(19) United States
(12) Patent Application Publication
(10) Pub. No.: US 2012/0198626 A1
(43) Pub. Date: Aug. 9, 2012

(54) PATIENT SUPPORT APPARATUS WITH MULTIPURPOSE FOOT DECK SECTION

(76) Inventor: Sandy M. RICHARDS, Pershing, IN (US)

(21) Appl. No.: 13/020,184

(22) Filed: Feb. 3, 2011

(51) Int. Cl. A61G 7/008; A61G 7/16; A61G 7/053; A61G 7/012; A61G 7/015

(52) U.S. Cl. 5/607; 5/611

(57) ABSTRACT

A patient support apparatus includes a frame movable to a plurality of vertical positions, a first deck section pivotable relative to the frame and a second deck section pivotable relative to the first deck section. The second deck section includes a base, a coupler movable relative to the base, and an extender movable relative to the coupler and the base. The base and extender cooperate to define a support surface when the second deck section is in a generally horizontal position. The extender is positionable to provide egress handles when the second deck section is in the generally vertical position.

### BACKGROUND

The present invention relates generally to patient support apparatus movable between a bed position and a chair egress position. More specifically, the present invention relates to patient support apparatus that includes a deck section that is convertible between a support surface when the patient support apparatus is in the bed position and an egress handle when the patient support apparatus is in the chair egress position.

Hospital beds may have a head siderail assembly coupled to a head portion of the support surface and a foot siderail assembly coupled to a seat portion of the support surface. The siderail assemblies may be movable independently of one another between a raised position and a lowered position. The siderail assemblies may be used in the raised position to retain patients resting on the support surface and in the lowered position to transfer patients from the bed to another support apparatus, allow a caregiver improved access to the patient, or to help with entering and exiting the bed. In some patient support apparatuses such as the Hill-Rom® TotalCare® bed, for example, the bed is capable of being moved to a position in which a patient may exit, or egress, from the foot end of the bed when the bed has been moved to a chair configuration. This position is generally known as the chair egress position. In the chair egress position, the upper frame may be tilted relative to the lower frame, the foot deck section may be pivoted relative to the thigh deck section, and the head deck sections may be pivoted relative to the upper frame.

It is also known that patients egress from a side of the bed. Before the patient is able to egress, the patient must rotate the patient's body on the support surface to face toward the side, swing the patient's legs over the side of the bed, and remain sitting in an upright position without support from the support surface to the patient's back. Such coordinated movement to egress from the side of the bed may be difficult for some patients. As a result, egress from the chair position of the bed may be more suitable to some patients. With the bed in the chair position, the patient begins with the patient's feet resting on the floor, the patient sitting in the upright position, and the patient's back being supported by the support surface. To egress from the bed, the patient supports a portion of the patient's weight on the support surface on each side of the patient or on a caregiver standing next to the bed. The patient then leans forward and transfers the remaining weight to the patient's feet.

### SUMMARY

The present application discloses one or more of the features recited in the appended claims and/or the following features which, alone or in any combination, may comprise patentable subject matter.

According to a first aspect of the present disclosure, a patient support apparatus may include a frame movable to a plurality of vertical positions, and a first deck section pivotable relative to the frame. The patient support apparatus may also include a second deck section pivotable relative to the first deck section. The second deck section may be movable between a generally horizontal position and a generally vertical position. The second deck section may include a base, a coupler movable relative to the base, and an extender movable relative to the coupler and the base. The base and extender may cooperate to define a support surface when the second deck section is in the generally horizontal position. The extender may be positionable to provide egress handles when the second deck section is in the generally vertical position.

In some embodiments the extender translates relative to the coupler. The coupler may also translate relative to the base. Also, the extender may pivot relative to the base.

In some embodiments, the patient support apparatus has a longitudinal axis defined by the longitudinal length of the patient support apparatus. The extender may pivot relative to the base about an axis that is generally parallel to the longitudinal axis of the patient support apparatus when the second deck section is in the generally horizontal position.

In some embodiments, the coupler includes a first slide block, a second slide block, and a hinge having a first part coupled to the first slide block and a second part coupled to the second slide block.

The base may include a first guide and the extender may include a second guide. The first slide block may be received in the first guide such that the coupler translates along the first guide. The second slide block may be received in the second guide such that the extender translates relative to the coupler.

In some embodiments the base includes a lock to secure the coupler relative to the base. The extender may also include a lock to secure the extender relative to the coupler.

The patient support apparatus may be movable between a bed position and a chair egress position and the second deck section is in the generally vertical position when the patient support apparatus is in the chair egress position.

According to another aspect of the present disclosure, a patient support apparatus may include a lower frame and an upper frame movable vertically relative to the lower frame. The patient support apparatus may also include a deck including a head deck section, a thigh deck section, and a foot deck section. The head deck section may be movable relative to the upper frame about a first generally horizontal axis. The thigh deck section may be movable relative to the upper frame about a second generally horizontal axis. The foot deck section may be movable relative to the thigh deck section about a third generally horizontal axis. The foot deck section may include a first portion pivotably coupled to the thigh section and pivotable about the third generally horizontal axis. The foot deck section may also include a second portion pivotable relative to the first portion about a fourth axis that is generally perpendicular to the third generally horizontal axis regardless of the position of the first portion.

In some embodiments the foot deck section further includes a hinge coupling the first portion to the second portion. The hinge may be translatable relative to the first portion. The second portion may be translatable relative to the hinge.

In some embodiments, the foot deck section includes a plurality of locks with a first lock securing the hinge relative to the first portion and a second lock securing the second portion relative to the hinge.

The second portion of the foot deck section may be movable to a position wherein the second portion forms an egress handle.

In some embodiments, the second portion engages the first portion when the second portion is in the position in which the second portion forms an egress handle such that engagement of the second portion with the first portion prevents rotation of the second portion relative to the first portion.

In some embodiments, the hinge may include a first slide block engaged with the first portion of the foot deck section and a second slide block engaged with the second portion of the foot deck section. The first and second portion may each include a guide, the respective slide blocks received in the guides.

Additional features and advantages of the invention will become apparent to those skilled in the art upon consideration of the following detailed description of illustrated embodiments exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of a patient support apparatus that is reconfigurable between a bed configuration and a chair egress configuration, the patient support apparatus having a reconfigurable deck section that provides a support surface in the bed position and egress handles when the patient support apparatus is in the chair egress configuration;

FIG. 2 is a side view of a portion of the patient support apparatus of FIG. 1 with the reconfigurable deck section configured as a support surface;

FIG. 3 is a side view of the patient support apparatus of FIG. 1 similar to FIG. 2, but with the reconfigurable deck section configured as egress handles;

FIG. 4 is a top view of a portion of the patient support apparatus of FIG. 1;

FIG. 5 is an enlarged side view of a portion of the patient support apparatus of FIG. 1, viewed from the patient left side and showing a coupler between a base portion of the reconfigurable deck section and an extender of the reconfigurable deck section;

FIG. 6 is a cross-sectional view taken along lines 6-6 in FIG. 5;

FIG. 7 is a cross-sectional view taken along lines 7-7 in FIG. 5;

FIG. 8 is a side view of the base portion of the reconfigurable deck section viewed from the patient left side of the bed;

FIG. 9 is a view similar to FIG. 4 showing one of two extenders of the reconfigurable deck section pivoted relative to the base portion of the reconfigurable deck section;

FIG. 10 is a view similar to FIG. 7 showing engagement of an extender of the reconfigurable deck section with the base portion of the reconfigurable deck section; and

FIG. 11 is a view similar to FIG. 5, showing the extender moved relative to the coupler.

### DETAILED DESCRIPTION OF THE DRAWINGS

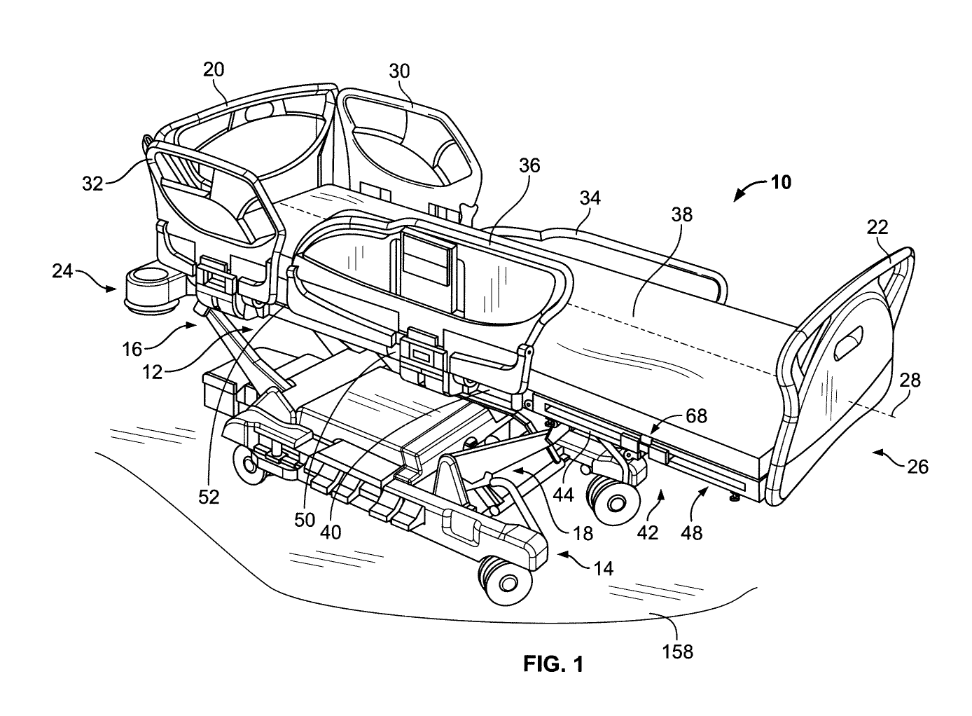

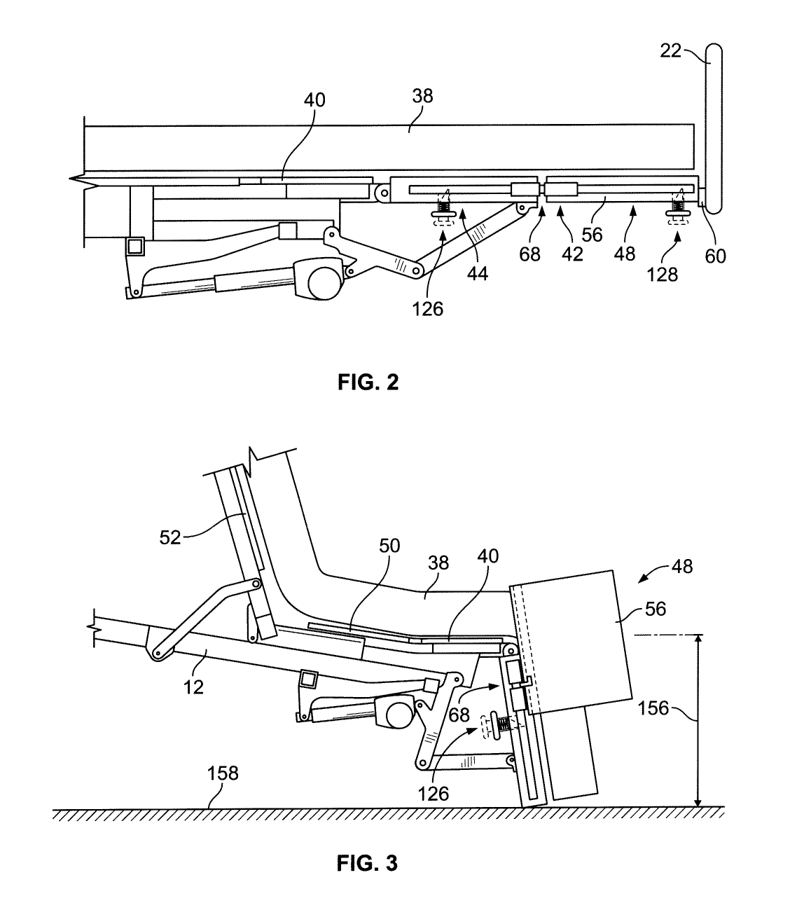

A patient support apparatus illustratively embodied as a hospital bed 10 is movable between a bed position as shown in FIG. 1 and a chair egress position shown in FIG. 3. The hospital bed 10 includes an upper frame 12 that is movable vertically relative to a lower frame 14, with a pair of head end lift arms 16 and a pair of foot end lift arms 18 supporting upper frame 12. The head end lift arms 16 are driven by a first actuator (not shown) and the foot end lift arms 18 are driven by a second actuator (not shown). The hospital bed 10 is positioned with a foot end 26 shown on the right side of FIG. 1 and a head end 24 shown on the left side of FIG. 1. Reference to the head end 24 and foot end 26 is made for orientation only and is not to identify any specific structure on the hospital bed 10. A head end panel 20 is supported on the upper frame 12. The hospital bed 10 also includes a number of deck sections supported on the upper frame 12 including a head deck section 52 which may be moved to a raised position as shown in FIG. 3. A seat deck section 50 is fixed to the upper frame 12 in the illustrative embodiment shown in FIGS. 1-3. A thigh deck section 40 is pivotable relative to the upper frame 12 between a lowered position shown in FIG. 2 and a raised position shown in FIG. 3. A foot deck section 42 is pivotable relative to the thigh deck section 40 and includes a base 44 and an extension 48. A foot end panel 22 is supported from the extension 48 of the foot deck section 42.

In the illustrative embodiment of FIG. 1, the deck sections 42, 40, 50, 52 support a mattress 38. In the bed position shown in FIG. 1, the deck sections 42, 40, 50, 52 cooperate to define a length of the hospital bed 10 that extends from the head end 24 to the foot end 26. A longitudinal axis 28 extends along the length of the hospital bed 10. As shown in FIG. 1, the hospital bed includes a patient left head side rail 30, a patient left foot side rail 34, a patient right head side rail 32, and a patient left foot side rail 36. These side rails 30, 32, 34, and 36 cooperate with the foot end panel 22 and the head end panel 22 define a boundary about the mattress 38 when the side rails 30, 32, 34 and 36 are in the raised position.

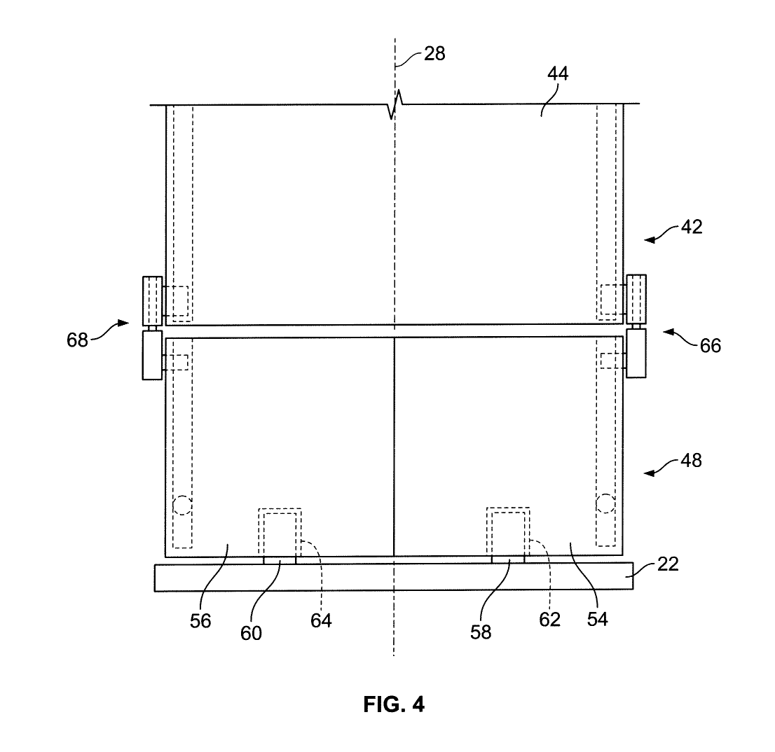

The foot deck section 42 is reconfigurable from the arrangement shown in FIG. 1 where the extension 48 provides a support surface for a portion of the mattress 38 to the arrangement shown in FIG. 3 in which the extension 48 serves as egress handles on opposite sides of the hospital bed 10. The egress handles may be used by a patient when exiting the foot end of the bed 10 when it is in the chair egress configuration. Referring now to FIG. 4, the extension 48 includes two panels 54, 56 which may be positioned adjacent to one another to cooperate with the base 44 to form a support surface for the mattress 38. The foot end panel 22 includes two arms 58, 60 which engage with the panels 54, 56 respectively to secure the panels 54, 56 in the arrangement shown in FIGS. 1 and 4. The panel 54 includes a cavity 62 into which the arm 58 of the foot end panel 22 is received. Similarly, panel 56 is formed to include a cavity 64 into which the arm 60 of the foot end panel 22 is received.

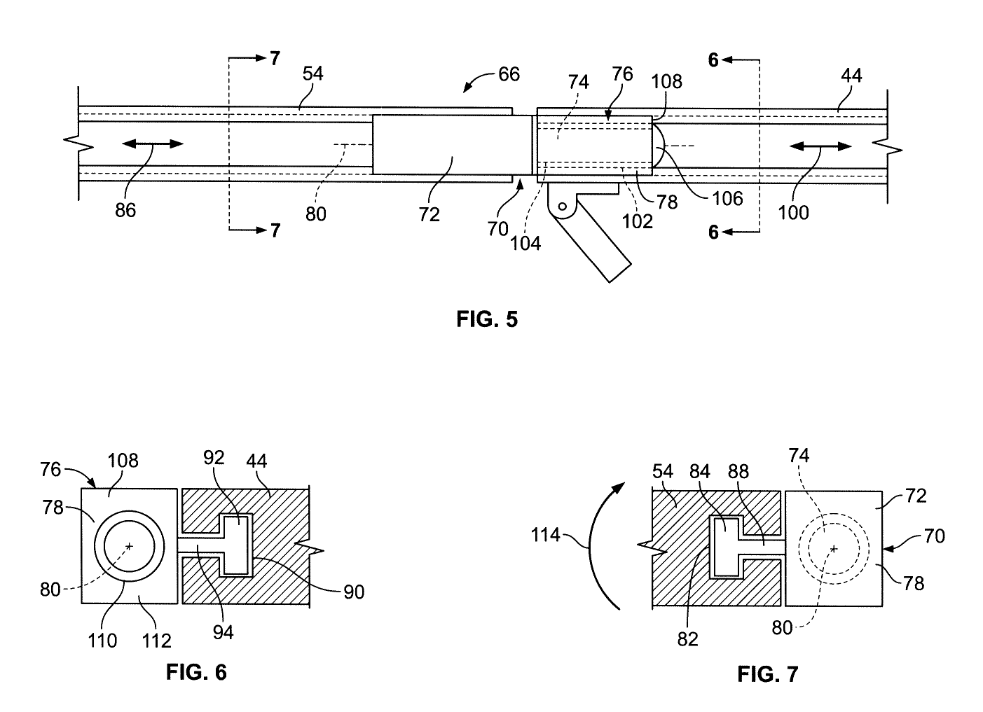

Each of the panels 54, 56 is supported from the base 44 by a respective hinge 66, 68. The discussion hereinafter will be with specific reference to hinge 66 but it should be understood that the disclosure with regard to hinge 66 is equally applicable to hinge 68. The hinge 66 is movable relative to the base 44 and the panel 54 is movable relative to the hinge 66 as will be discussed in further detail below. As shown in FIG. 5, the hinge 66 includes a base 70 that includes a mount 72 and a shaft 74. The shaft 74 is received in a pivot arm 76 which is formed to include a journal 78 into which the shaft 74 is received such that the shaft 74 pivots in the journal 78 about an axis 80. The panel 54 is formed to include a channel 82 which acts as a guide into which a follower 84 of the base 70 is received for sliding movement in the direction of the arrow 86 shown in FIG. 5. The follower 84 is coupled to the mount 72 of the base 70 by a stem 88. The channel 82 is a c-shaped channel with the stem 88 being positioned in the opening of the c-shaped channel to maintain the orientation of the base 70 relative to the 54. In the illustrative embodiment, the base 70 and the pivot arm 76 are each formed of a polymer having good wear and strength characteristics such that they are suited to move in the channel 82 with minimal friction for a number of cycles.

The base 44 is formed to include another c-shaped channel 90 similar to the c-shaped channel 82 formed in panel 54. The pivot arm 76 includes a follower 92 and a stem 94 which secures the follower 92 to the journal 78. The follower 92 moves in the channel 98 in the direction of arrow 100 shown in FIG. 5. The journal 78 is formed to include a cylindrical bearing surface 102 which engages a cylindrical surface 104 of the shaft 74 wherein the base 70 rotates about axis 80 relative to pivot arm 76. In the illustrative embodiment, the shaft 74 is secured to the journal 78 by a retainer 106 that is formed by mechanically displacing a portion of the shaft 74 that extends beyond any and 108 of the journal 78. The mechanical displacement forms a flange 110 shown in FIG. 6 that overlies a portion of the surface 112 of the end 108 of the journal 78.

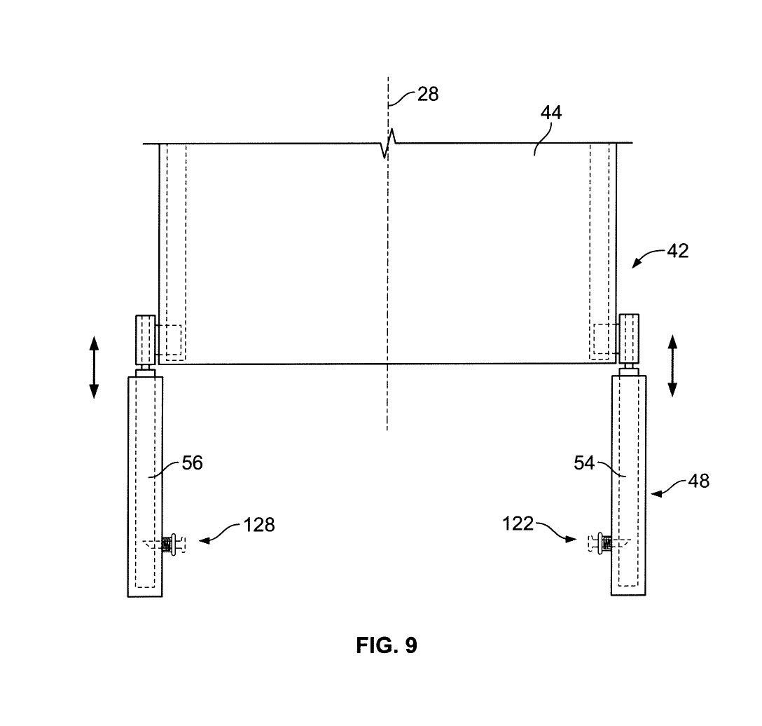

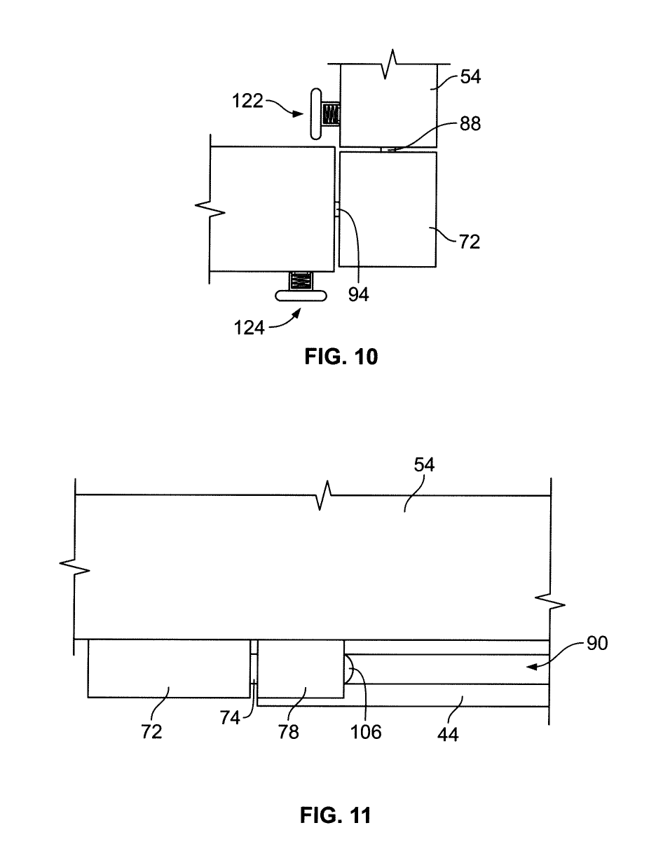

When the arms 58 and 60 are positioned in the cavities 62 and 64, respectively, the panels 54 and 56 are positioned to form a support surface for the mattress 38. When the foot end panel 22 is removed from the extension 48, the panels 54 and 56 are pivotable relative to the base 44 on the respective hinges 66 and 68. For example, panel 54 is supported by the pivot arm 70 of hinge 66 and is pivotable about the axis 80 as the pivot arm 70 pivots about the axis 80. Pivoting if the panel 54 about the axis 80 in the direction of the arrow 114 shown in FIG. 7, the panel 54 is moved to a first position as shown in FIG. 9. Movement of the panel 54 relative to the pivot arm 70 toward the base 44 in the direction of the arrow 86 shown in FIG. 5 results in a bottom surface 118 of the panel 54 engaging a side surface 120 of the base 44 so that the panel 54 is restrained from pivoting about the axis 80 during the engagement of surface 118 with surface 120 as shown in FIG. 10.

Referring now to FIG. 11, sliding of panel 54 relative to the pivot arm 70 causes the pivot arm 70 to engage an end of the c-shaped channel 82 and the hinge 66 is maintained in position by a retainer 122 (not shown in FIG. 11) which is a spring-loaded latch that engages the follower 84 to retain the follower 84 at the foot end of the panel 54. The hinge 66 can then be translated or slid along the c-shaped channel 90 formed in the base 44 so that the hinge 66 is moved to the head end of the base 44 as shown in FIG. 3. The hinge 66 is retained in position at the head end of the base 44 by a retainer 124 that engages the follower 92 of the base 76 of the hinge 66. The retainer 124 is a spring-loaded latch similar to the retainer 122.

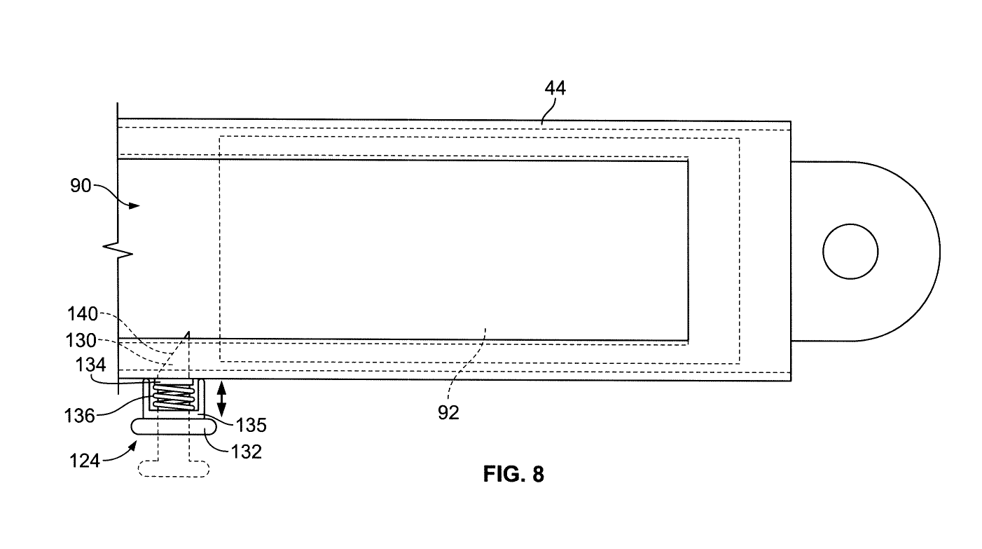

The retainer 124 is shown in FIG. 8 and includes a shaft 130 that moves relative to the base 44. A handle 132 is coupled to the shaft 130 and is grasped by a user to disengage the retainer 124 from the follower 92 of the base 76. A flange 134 coupled to the shaft 130 engages an extension spring 136 that is trapped between the flange 134 and a support 138 secured to the base 44. The extension spring 136 biases the flange 134 into contact with the base 44. The flange 134 is secured to the shaft 130 so that the shaft 130 is urged into the c-shaped channel 90 of the base 44. The shaft 130 has an inclined surface 140 which may be engaged by the follower 92 so that a force on the follower 92 acts on the inclined surface 140 to urge the shaft 130 outwardly as shown in phantom in FIG. 8. The follower 92 then moves over the shaft 130 until the follower 92 clears the shaft 130 and the shaft 130 is urged by the compression spring 136 acting on the flange 134 and a frame 135 to the position shown in solid in FIG. 8. The shaft 130 has a flat surface 142 positioned on the side opposite the inclined surface 140. The flat surface 142 engages the follower 92 (shown in phantom in FIG. 8) to retain the follower 92 in position until a user releases the follower 92 by grasping the handle 132 of the retainer 124 and pulling the shaft 130 out of engagement with the follower 92 so that the follower 92 is free to move in the c-shaped channel 90.

The panel 56 also includes a retainer 128 and the base 44 includes a second retainer 126 on the opposite side from the retainer 124, as shown in FIGS. 1-4. The retainers 146 and 148 function similarly to the retainers 122 and 124, respectively. The hinge 68 has a structure similar to the hinge 66. A c-shaped channel 150 formed in panel 56 allows movement of the panel 56 relative to the follower 84 of hinge 68. A c-shaped channel 152 formed in base 44 allows the follower 92 of hinge 68 to move in the c-shaped channel 152 to move the hinge 68 relative to the base 44.

With the structure heretofore described, a user may reconfigure the hospital bed 10 from the bed configuration shown in FIGS. 1 and 2 to a chair egress configuration as shown in FIG. 3. By moving the panels 54 and 56 into the egress handle configuration, the length of the foot deck section 42 is shortened so that the height 156 of the seat deck section 50 and the thigh deck section 40 above the floor 158 may be minimized because of the reduced length of the foot deck section 42. This permits a user to optimize the height of the bed 10 for the chair egress position for a given patient without being limited by the full length of the foot deck section 42 when it is in the bed configuration.

Although the invention has been described with reference to the preferred embodiments, variations and modifications exist within the scope and spirit of the invention as described and defined in the following claims.

1. A patient support apparatus comprising
a frame movable to a plurality of vertical positions,
a first deck section pivotable relative to the frame,
a second deck section pivotable relative to the first deck section, the second deck section movable between a generally horizontal position and a generally vertical position, the second deck section including a base, a coupler movable relative to the base, and an extender movable relative to the coupler and the base, the base and extender cooperating to define a support surface when the second deck section is in the generally horizontal position and positionable to provide egress handles when the second deck section is in the generally vertical position.

2. The patient support apparatus of claim 1, wherein the extender translates relative to the coupler.

3. The patient support apparatus of claim 2, wherein the coupler translates relative to the base.

4. The patient support apparatus of claim 3, wherein the extender pivots relative to the base.

5. The patient support apparatus of claim 4, wherein the patient support apparatus has a longitudinal axis defined by the longitudinal length of the patient support apparatus and wherein the extender pivots relative to the base about an axis that is generally parallel to the longitudinal axis of the patient support apparatus when the second deck section is in the generally horizontal position.

6. The patient support apparatus of claim 1, wherein the patient support apparatus has a longitudinal axis defined by the longitudinal length of the patient support apparatus and wherein the extender pivots relative to the base about an axis that is generally parallel to the longitudinal axis of the patient support apparatus when the second deck section is in the generally horizontal position.

7. The patient support apparatus of claim 6, wherein the coupler includes a first slide block, a second slide block, and a hinge having a first part coupled to the first slide block and a second part coupled to the second slide block.

8. The patient support apparatus of claim 7, wherein the base includes a first guide and the extender includes a second guide, the first slide block received in the first guide such that the coupler translates along the first guide, the second slide block received in the second guide such that the extender translates relative to the coupler.

9. The patient support apparatus of claim 8, wherein the base includes a lock to secure the coupler relative to the base.

10. The patient support apparatus of claim 9, wherein the extender includes a lock to secure the extender relative to the coupler.

11. The patient support apparatus of claim 10, wherein the patient support apparatus is movable between a bed position and a chair egress position and the second deck section is in the generally vertical position when the patient support apparatus is in the chair egress position.

12. A patient support apparatus comprising
a lower frame,
an upper frame movable vertically relative to the lower frame,
a deck including a head deck section, a thigh deck section, and a foot deck section, the head deck section movable relative to the upper frame about a first generally horizontal axis, the thigh deck section movable relative to the upper frame about a second generally horizontal axis, and the foot deck section movable relative to the thigh deck section about a third generally horizontal axis,
wherein the foot deck section includes a first portion pivotably coupled to the thigh section and pivotable about the third generally horizontal axis and second portion pivotable relative to the first portion about a fourth axis that is generally perpendicular to the third generally horizontal axis, regardless of the position of the first portion.

13. The patient support apparatus of claim 12, wherein the foot deck section further includes a hinge coupling the first portion to the second portion.

14. The patient support apparatus of claim 13, wherein the hinge is translatable relative to the first portion.

15. The patient support apparatus of claim 14, wherein the second portion is translatable relative to the hinge.

16. The patient support apparatus of claim 13, wherein the hinge is translatable relative to the first portion and the second portion is translatable to the hinge, and wherein the foot deck section includes a plurality of locks with a first lock securing the hinge relative to the first portion and a second lock securing the second portion relative to the hinge.

17. The patient support apparatus of claim 16, wherein the second portion of the foot deck section is movable to a position wherein the second portion forms an egress handle.

18. The patient support apparatus of claim 17, wherein the second portion engages the first portion when the second portion is in the position in which the second portion forms an egress handle such that engagement of the second portion with the first portion prevents rotation of the second portion relative to the first portion.

19. The patient support apparatus of claim 16, wherein the hinge includes a first slide block engaged with the first portion of the foot deck section and a second slide block engaged with the second portion of the foot deck section.

20. The patient support apparatus of claim 19, wherein the first and second portion each include a guide, the respective slide blocks received in the guides.
